(19) United States
(12) Patent Application Publication
(10) Pub. No.: US 2025/0165275 A1
(43) Pub. Date: May 22, 2025

(54) SPEED BRIDGE FOR EMULATION HARDWARE

(71) Applicant: Hong Kong Applied Science and Technology Research Institute Company Limited, Hong Kong (HK)

(72) Inventors: Chi Wai NG, Hong Kong (HK); Eric Kwong Hang TSANG, Hong Kong (HK)

(73) Assignee: Hong Kong Applied Science and Technology Research Institute Company Limited, Hong Kong (HK)

(21) Appl. No.: 18/512,428

(22) Filed: Nov. 17, 2023

(51) Int. Cl. G06F 9/455

(52) U.S. Cl. CPC G06F 9/45508; G06F 9/45558; G06F 2009/45591

(57) ABSTRACT

A speed bridge which provides high verification productivity in a hardware emulation system by allowing for time-efficient communication between a host/server and a device under test is disclosed. The speed bridge emulates the host to the device and the device to the host simultaneously while being in communication with both. When the message/response between the host and the device is fixed, the virtual host communicates with the virtual device. When the message/response requires physical interaction, the speed bridge passes the message/response between the host/server and the device.

### BACKGROUND OF THE INVENTION

### 1. Field of the Invention

Aspects of the present invention relate to a speed bridge to achieve high verification productivity in a hardware emulation system between a host/server and a device being developed or tested. It is particularly useful for bridging between fast servers such as an Electronic Design Automation (“EDA”) server and a slow device-under-test (“DUT”) for hardware emulation.

### 2. Description of the Related Art

High-speed integrated circuits (“IC”) such as Ethernet chips, USB3.0 chips, and PCle chips are widely used in all manner of devices, including general purpose computers, application-specific devices, and Internet-of-Things devices at the consumer, business, and scientific levels. To design these high-speed IC system-level emulation is needed. While emulation can be done entirely in software, for purposes of this application the word “emulator” will be used to describe an emulator which could use software, hardware, or both.

While emulation—the process of using an emulator to mimic the responses of a separate device to a given input for design and testing purposes—is well known in the art, current emulation devices and methods are lacking in several ways.

First, the process of receiving, processing, and sending an input to the emulation device, running it through the emulator's processing routines, determining the emulated device's response, and sending it back as an output, is extremely slow compared to the operation of an actual emulated device, which does this with dedicated circuitry and/or specialized software/firmware routines. This makes testing take much longer than it should, especially automated testing where inputs and outputs are created/monitored by a machine such as in EDA.

Relatedly, the slow speed and complex processing pathways of traditional emulators can cause data collisions, buffer overflows, and package losses as the emulator loses track of exactly which inputs it is processing and responding to. If this is addressed by using high-speed interfacing, resources are wasted as the actual data stream is usually quite small, relatively speaking.

A speed bridge to allow reliable, inexpensive, high-speed and efficient testing in emulation scenarios would be a useful invention. Aspects of the present invention address these concerns.

### SUMMARY OF THE INVENTION

Aspects of the present invention include a speed bridge device which simultaneously emulates both the DUT and the device which the DUT is communicating with (the “host” for purposes of this application.) Whenever the DUT has a fixed output to a particular input, the speed bridge simply produces the appropriate output from a high-speed solid state lookup pathway/processor. When the DUT could have a non-pre-defined response to an input, the speed bridge sends the input to the DUT, which processes it, responds, and sends the response to the speed bridge, which returns it to the host. Similarly, if an input from the DUT would produce a fixed output from the host, the speed bridge can perform the same function. The emulator(s) within the speed bridge will be referred to herein as the “virtual host “and the “virtual DUT”.

As a key component of deployment of high-performance system-level emulation, the present invention provides a high-speed I/O system which provides “last mile” connection between low speed devices/emulations and high-speed devices/emulations, which makes it possible to co-verify hardware and software with applications running on an Ethernet Physical Layer (“PHY”), dramatically improving verification productivity.

Additionally, the speed bridge can in both the virtual host and the virtual DUT store I/O data such that if either the host or the DUT are not ready to receive such data, that it can be subject to flow control and provide it in a timely way such that data collisions, buffer overflows, and packet losses are minimized or even eliminated. This allows the use of standardized communications protocols such as USB and Ethernet PHY even in environments where the host and/or the DUT would normally use faster or slower communications protocols.

In addition, the speed bridge enables rapid creation of system-level environments using the same hardware and software that the real silicon will use. The speed bridge can be built around standards-compliant interfaces; can be reused between projects; and runs full system enumeration connected to a real PC chipset running a real OS with a full USB software stack.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a parts diagram of the basic structure of the invention.

FIG. 2 is an abstract schematic of a USB-based host device.

FIG. 3 is a schematic of a first configuration of the invention using Ethernet PHY FIG. 4 is an abstract schematic of the components of the invention.

FIG. 5 is an abstract schematic of the first configuration of the invention.

FIG. 6 is an abstract schematic of a second configuration of the invention.

FIG. 7 is a flow chart showing the flow of the software configuration of the invention.

FIG. 8 is a flow chart showing the flow of the operation of the invention.

FIG. 9 is a representation of the implementation of the “pause frame” step used by the software controlling the invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Persons of ordinary skill in the art will note that ultrasonic imaging can be applied to a wide variety of materials other than biological structures. An embodiment of the method will be described in terms of a medical diagnostic ultrasound imaging device. However, there are numerous other applications of the present invention. The usefulness of the present invention is by no means limited to such medical diagnostic uses.

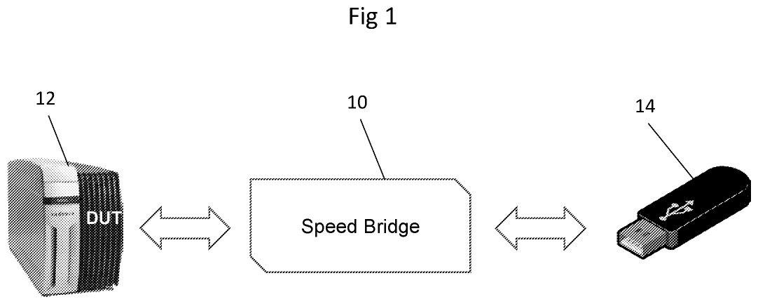

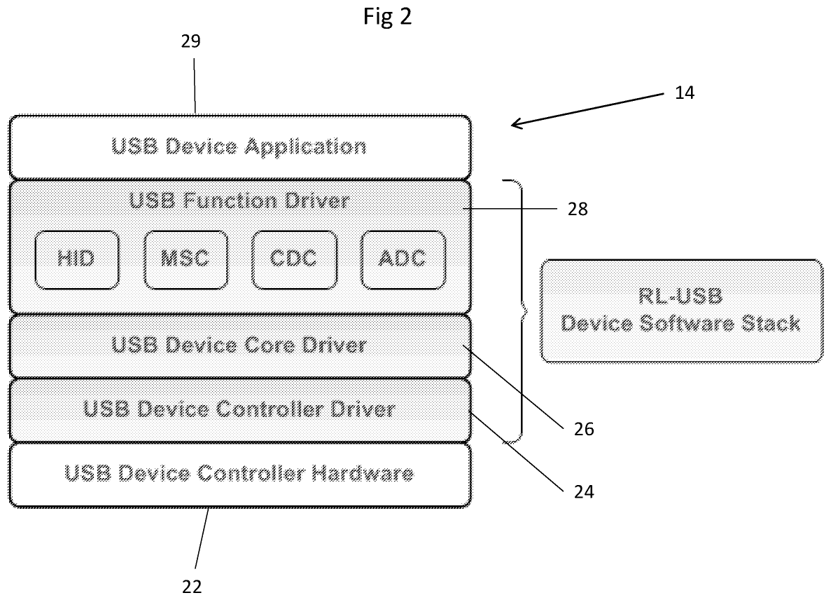

By referring to FIG. 1 and FIG. 2, a DUT 12 communicates with speed bridge 10 to receive test input and output data or signals. Speed bridge 10 communicates with host 14, here a USB device running an emulation application as set forth in FIG. 2. Host 14 could be a general purpose computer connected to the speed bridge by any reasonable means (including but not limited to USB, Ethernet, SCSI, or SATA,) a special-purpose device, a cloud server, or any other reasonable device which can communicate with the speed bridge.

In the embodiment shown, host 14 is a USB device which includes all of the components shown in FIG. 2. This includes controller hardware 22, controller driver 24, device core driver 26, function drivers 28, and an application layer 29. The necessary software to perform the functions of a host device runs in application layer 29 and is stored in memory onboard the USB device (not shown.)

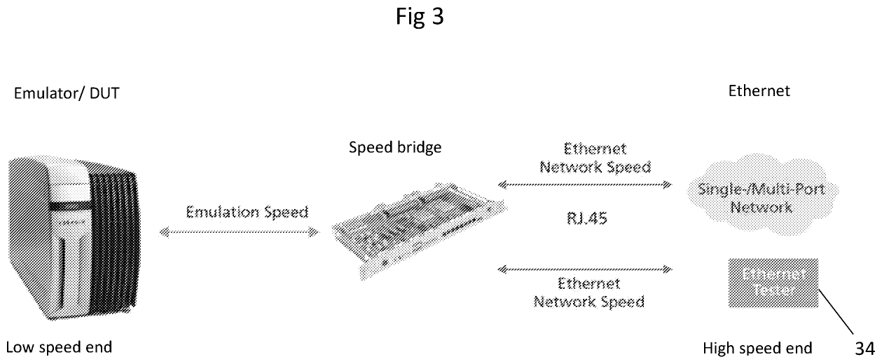

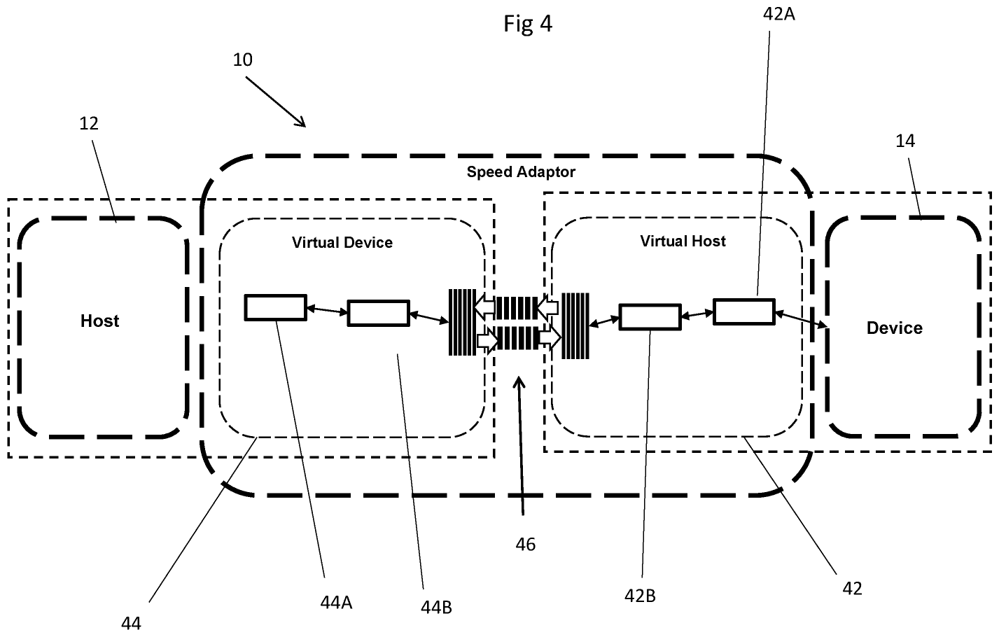

FIG. 3 shows an alternate configuration wherein host 14 (see FIG. 1) has been replaced by a single and/or multiport network which communicates with one or more Ethernet-connected hosts 34. Instead of connecting via USB and/or running on a USB-stack device as in FIG. 2, the host is connected through the Ethernet protocol. A single-port network configuration could also include a direct Ethernet connection to Ethernet-connected host 34.

FIG. 4 shows the internal components of the speed bridge 10. Host 12 communicates with virtual DUT 44, which comprises DUT virtual emulator 44A and DUT data flow controller 44B. Through asynchronous controller 46, virtual device 44 communicates with virtual host 42, which likewise comprises host virtual emulator 42A and host data flow controller 42B. In turn, virtual host 42 communicates with DUT 14.

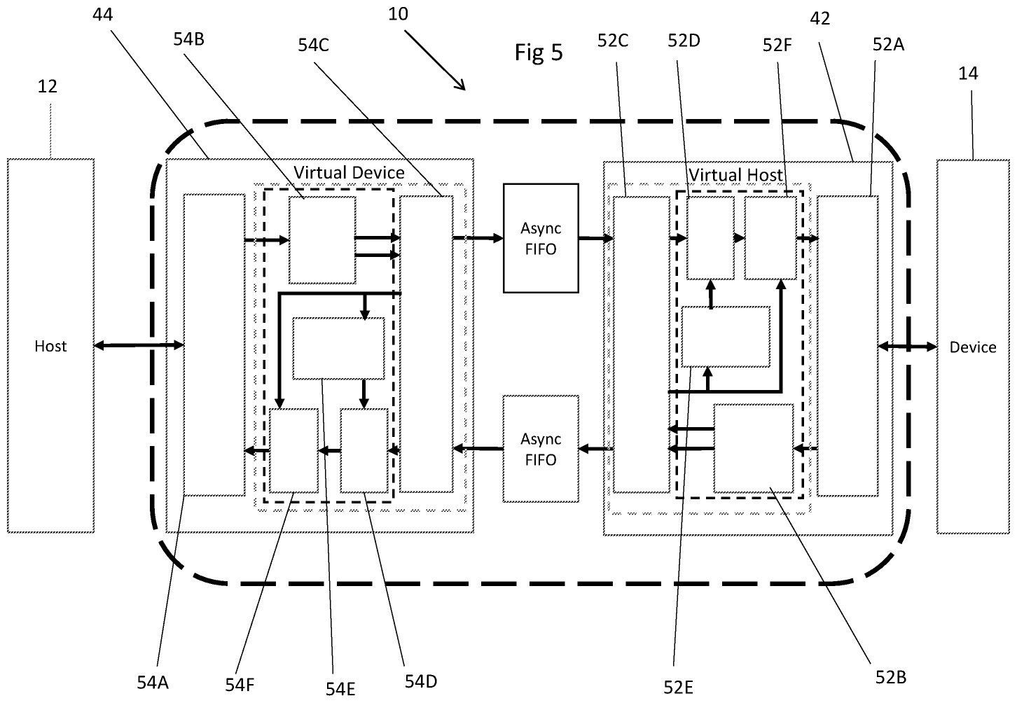

FIG. 5 shows a first configuration of the speed bridge configured to work through an Ethernet PHY network and incorporating acceleration components. Host 12 is now configured as a cloud server connecting to speed bridge 10 via a physical Ethernet connection. Host 12 connects to virtual DUT 44 through virtual DUT physical Ethernet connection 54A. An input signal is then transmitted to DUT protocol decoder 54B and thus to DUT flow controller 54C. DUT protocol decoder 54B determines whether the incoming input signal is of a predefined type. If so, DUT data flow controller 54C obtains the predefined response from DUT programmable memory 54E and/or DUT virtual client 54D and sends it back to host 12 without ever communicating with either virtual host 42 or DUT 14. This provides a massive acceleration to the response time of the emulator. As an example of a predefined input signal, the host might ask the virtual DUT for its MAC address, a common security-related request of any network-capable device. As a MAC address can be predefined and changed easily, the desired response can be stored in the DUT programmable memory 54E and sent to the host 12 upon demand without ever communicating with the virtual host 42 or the DUT 14.

If the incoming signal is not of a predefined type, the DUT data flow controller sends the signal to the virtual host 42 via the asynchronous controller as shown in FIG. 4. Virtual host 42 then sends the signal to DUT 14, which processes it and returns a response/output signal to virtual host 42 and thence ultimately to host 12 if required or to virtual client 54D if not.

Further, DUT 14 connects to virtual host 42 through virtual host physical Ethernet connection 52A. An input signal is then transmitted to host protocol decoder 52B and thus to host flow controller 52C. Host protocol decoder 52B determines whether the incoming input signal is of a predefined type. If so, host data flow controller 52C obtains the predefined response from host programmable memory 52E and/or host virtual client 52D and sends it back to DUT 14 without ever communicating with either virtual DUT 44 or host 12. This likewise provides a massive acceleration to the response time of the emulator. As an example of a predefined input signal, the DUT might ask the virtual host for its version number, a common interopability-related request of any network-capable device. As a version number can be predefined and changed easily, the desired response can be stored in the DUT programmable memory 54E and sent to the host 12 upon demand without ever communicating with the virtual host 42 or the DUT 14.

If the incoming signal is not of a predefined type, the host data flow controller sends the signal to the virtual DUT 44 via the asynchronous controller as shown in FIG. 4. Virtual DUT 44 then sends the signal to host 12, which processes it and returns a response/output signal to virtual DUT 44 and thence ultimately to DUT 14 if required or to virtual client 52D if not.

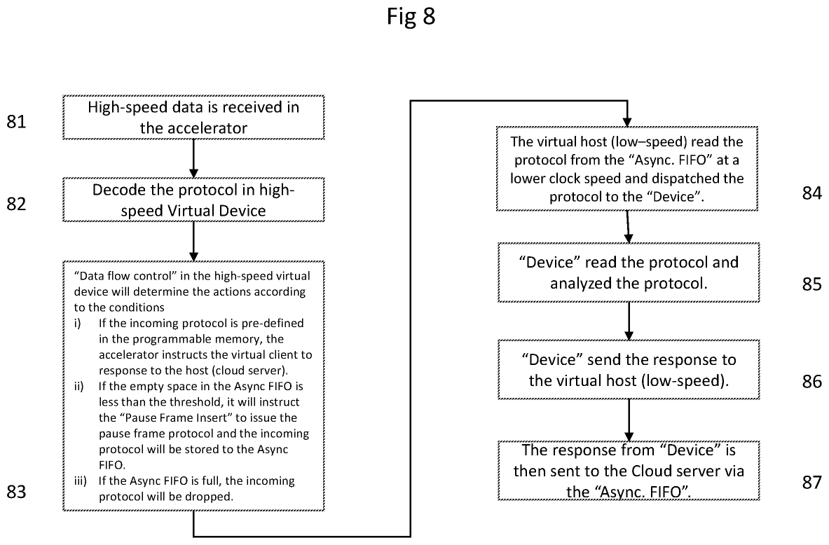

As it is common for hosts and DUT to have different signal clock speeds, pause frame inserts can be used to help buffer signals/requests between the host⇔virtual DUT and/or the DUT⇔virtual host. DUT data flow controller 54C can detect how much capacity the asynchronous communications device has to send/receive signals. If this is below a certain threshold, DUT data flow controller 54C can instruct DUT pause frame insert 54F to issue a pause frame protocol signal, which will cause the incoming signal to be stored to the FIFO queue on the asynchronous communications device until adequate capacity is available. (See FIG. 8.)

Similarly, host data flow controller 52C can detect how much capacity the asynchronous communications device has to send/receive signals. If this is below a certain threshold, host data flow controller 52C can instruct host pause frame insert 52F to issue a pause frame protocol signal, which will cause the incoming signal to be stored to the FIFO queue on the asynchronous communications device until adequate capacity is available.

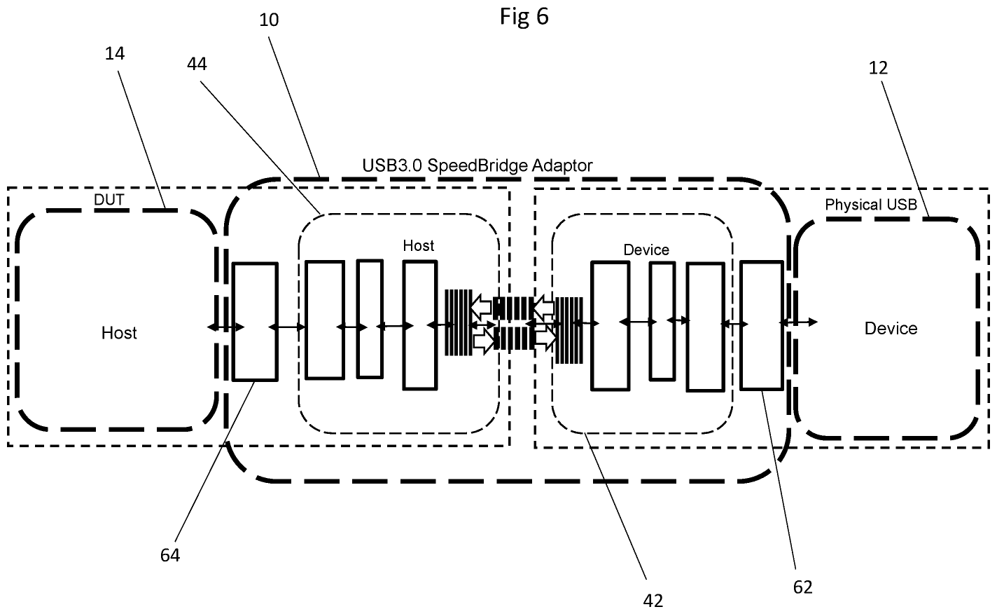

FIG. 6 shows a second configuration of the speed bridge wherein the host and the DUT communicate with the speed bridge through a physical USB-3 connection, but which emulates a physical Ethernet connection. As USB-3 is faster than Ethernet, this allows testing of a DUT which will ultimately use an Ethernet connection at the speed of USB-3. Host 14 communicates with virtual DUT 44 through virtualized DUT Ethernet connection 64. Similarly, DUT 12 communicates with virtual host 42 through virtualized host Ethernet connection 62. Otherwise, this configuration is similar to that shown in FIG. 5.

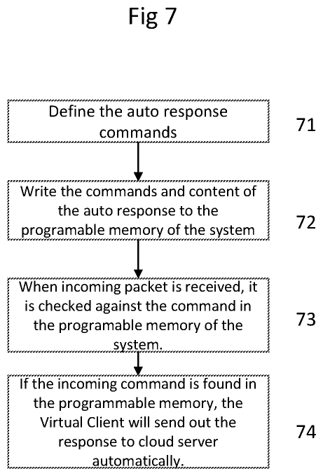

FIG. 7 shows the operation flow of the auto response feature. In Step 71, auto response commands (for either the virtual host or the virtual DUT as appropriate) are pre-defined. In Step 72, these commands and the corresponding responses are written to the programmable memory of the appropriate virtual device. In Step 73, when the virtual device receives a signal from a physical device, it checks the content of the signal against the stored auto response commands in the programmable memory. If the command is found, in Step 74, the virtual client of the virtual device will send the corresponding response to the physical device.

FIG. 8 shows the operation flow of the acceleration features (including the auto response feature) of the invention. In Step 81, high-clock-speed data is received in the accelerator portion of the speed bridge from one of the physical devices (the DUT or the host.) In Step 82, the high-clock-speed data is reviewed by the protocol decoder of one of the virtual devices from the corresponding physical device and sent to the data flow controller of that virtual device. In Step 83, the data flow controller then processes the incoming data. If the incoming data is a predefined signal as shown in FIG. 5 and FIG. 7, the accelerator portion of the speed bridge instructs the virtual client to send the predefined response stored in the programmable memory to the corresponding physical device. If the incoming data is not a predefined signal, but the asynchronous communications device has adequate capacity to send the data to the second virtual device, then the virtual device makes any necessary adjustments to the clock speed of the data and transmits it to the second virtual device (see Step 84.) If the asynchronous communications device does not have adequate capacity to send the data to the second virtual device, the accelerator portion instructs the pause frame insert to issue a pause frame protocol/signal and the data will be stored to the FIFO queue for transmission when the asynchronous communications device has adequate capacity. If the FIFO queue is full, the data will be dropped.

In Step 84, the virtual device makes any necessary adjustments to the clock speed of the data and sends it to the second virtual device. In Step 85, the second virtual device reads the signal. In Step 86, the second virtual device processes the data accordingly by sending it to the corresponding second physical device (the host or the DUT) and receiving a response. In Step 87, the response is sent from the second physical device to the second virtual device and thence ultimately back to the first physical device.

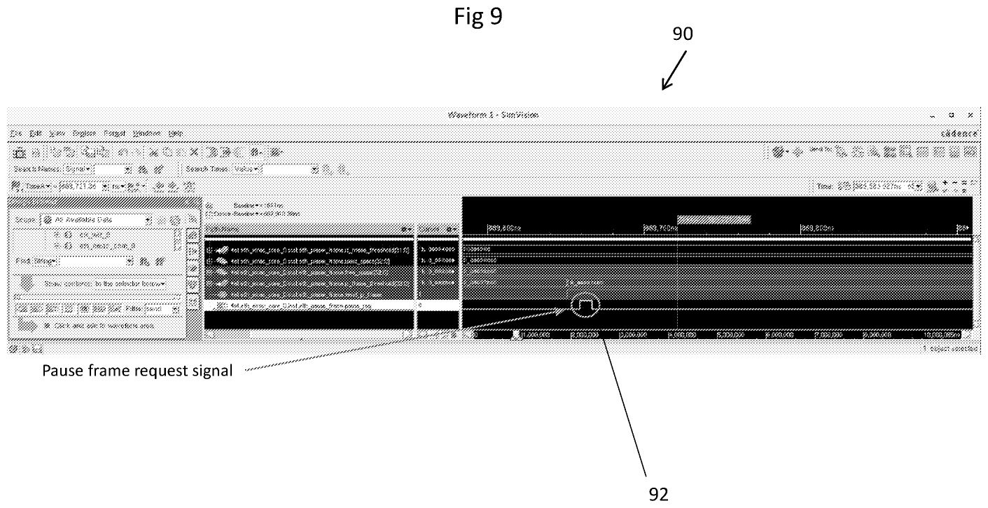

FIG. 9 shows an example of signal monitoring display 90. Signal monitoring information display 90 shows pause frame request 92, which would produce a pause frame operation in the virtual host or the virtual DUT as specified.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A speed bridge for emulation hardware comprising:
a virtual host comprising a host data flow controller and a host virtual emulator;
a virtual DUT comprising a DUT data flow controller and a DUT virtual emulator; and
an asynchronous communications device having a host queue and a DUT queue which allows the virtual host to communicate with the virtual DUT.

2. The speed bridge for emulation hardware of claim 1, further comprising:
a physical host which communicates with the virtual DUT; and
a physical DUT which communicates with the virtual host.

3. The speed bridge for emulation hardware of claim 2, wherein the DUT virtual emulator has a DUT virtual emulator memory which stores a fixed DUT output associated with a fixed DUT input, such that if the virtual host sends the fixed DUT input to the virtual DUT, the DUT virtual emulator returns the fixed DUT output without communicating with the physical DUT.

4. The speed bridge for emulation hardware of claim 2, wherein the host virtual emulator has a host virtual emulator memory which stores a fixed host output associated with a fixed host input, such that if the virtual DUT sends the fixed host input to the virtual host, the host virtual emulator returns the fixed host output without communicating with the physical host.

5. The speed bridge for emulation hardware of claim 3, wherein the host virtual emulator has a host virtual emulator memory which stores a fixed host output associated with a fixed host input, such that if the virtual DUT sends the fixed host input to the virtual host, the host virtual emulator returns the fixed host output without communicating with the physical host.

6. The speed bridge for emulation hardware of claim 2, wherein the host virtual emulator automatically responds to timing-critical inputs from the physical DUT.

7. The speed bridge for emulation hardware of claim 2, wherein the host virtual emulator periodically sends a synchronization message to the physical DUT.

8. The speed bridge for emulation hardware of claim 6, wherein the host virtual emulator periodically sends a synchronization message to the physical DUT.

9. The speed bridge for emulation hardware of claim 2, wherein the host data flow controller receives a first signal having a first clock speed from the virtual DUT and converts the first signal to a second signal having a second clock speed before transmitting the second signal to the physical DUT.

10. The speed bridge for emulation hardware of claim 2, wherein the DUT data flow controller receives a first signal having a first clock speed from the virtual host and converts the first signal to a second signal having a second clock speed before transmitting the second signal to the physical host.

11. The speed bridge for emulation hardware of claim 9, wherein the DUT data flow controller receives a first signal having a first clock speed from the virtual host and converts the first signal to a second signal having a second clock speed before transmitting the second signal to the physical host.

12. The speed bridge for emulation hardware of claim 2, wherein the virtual host further comprises a host pause frame insert such that the host pause frame insert can send a host pause frame protocol to the asynchronous communications device which will cause a virtual host input signal to be queued.

13. The speed bridge for emulation hardware of claim 2, wherein the virtual DUT further comprises a DUT pause frame insert such that the DUT pause frame insert can send a DUT pause frame protocol to the asynchronous communications device which will cause a virtual DUT input signal to be queued.

14. The speed bridge for emulation hardware of claim 12, wherein the virtual DUT further comprises a DUT pause frame insert such that the DUT pause frame insert can send a DUT pause frame protocol to the asynchronous communications device which will cause a virtual DUT input signal to be queued.
